(19) United States
(12) Patent Application Publication
(10) Pub. No.: US 2008/0229049 A1
(43) Pub. Date: Sep. 18, 2008

(54) PROCESSOR CARD FOR BLADE SERVER AND PROCESS.

(76) Inventors: Ashwini Kumar Nanda, Mohegan Lake, NY (US); Krishnan Sugavanam, Mahopac, NY (US)

Correspondence Address: GREENBLUM & BERNSTEIN, P.L.C., 1950 ROLAND CLARK DRIVE, RESTON, VA, 20191, US

(21) Appl. No.: 11/687,251

(22) Filed: Mar. 16, 2007

(51) Int. Cl. G06F 13/00

(52) U.S. Cl. 711/173

(57) ABSTRACT

System including a processor card containing at least two processors, and a memory card containing at least two memory units. At least one memory unit is associated with each processor. A controller dynamically allocates memory in the at least two memory units to the at least two processors.

### FIELD OF THE INVENTION

The invention generally relates to a system and process for a processor accessing main memory, and more particularly to a system and process in a blade server for multiple processors accessing main memory.

### BACKGROUND OF THE INVENTION

Blade servers with multiple processors (e.g., central processing units) per blade (card) are becoming increasingly popular as servers for commercial, scientific, and personal computing applications. The small form factor (e.g., 1 U) of such blades combined with the low power dissipation and high performance make these blade servers attractive for almost any computing application. Typically, a blade includes, e.g., two (2) processors and associated memory (e.g., DDR/RAMBUS, etc.) and south bridge chips for interfacing with external world, e.g., Ethernet, EPROM, USB, PCI Express, RAID, SCSI, SATA, Firewire, etc.

On typical blades, such as the 1 U blade, each processor can directly access a predefined number of associated discrete memory units, e.g., ten (10) 256 MB memory elements. However, in some instances, a processor may have a need for more memory than that allotted to it, whereas in other instances a processor may not require all the memory associated with it.

Component size and power dissipation are ever-present design considerations in computing architecture. The negative effects of increased physical size and power dissipation are compounded on a dual processor blade where each processor has dedicated memory. With area and power being a premium in these blades, efficient design is increasingly difficult.

For example, processors, e.g., the IBM STI cell processor, have enormous compute power, they are able to solve large problems, which require a large memory footprint that directly translates into mounting several memory units, e.g., dynamic random access memory (DRAM), dual inline memory modules (DIMMs), etc., on a 1 U blade. However, by increasing the number of modules, space becomes a premium due to the fixed dimensions of the 1 U blade. Moreover, heat dissipation problems likewise increase as more modules are added. Thus, this problem results in a relatively small ratio of memory capacity to compute power for a 1 U blade.

Moreover, as some processors may not require all their associated memory, this unused memory is essentially standing idle and is wasting the precious space on the blade.

### SUMMARY OF THE INVENTION

According to an aspect of the invention, a system includes a processor card containing at least two processors, and a memory card containing at least two memory units. At least one memory unit is associated with each processor. A controller dynamically allocates memory in the at least two memory units to the at least two processors.

In another aspect of the invention, a process of partitioning main memory between at least two processors in a blade server system includes receiving a request for specified sized memory from a first processor, communicating with a memory controller of another processor, and confirming to the first processor an allocation of space in the main memory associated with the another processor.

According to another aspect of the invention, a computer system includes a first processor and a second processor, main memory, and a controller to dynamically allocate the main memory to the at least two processors.

### BRIEF DESCRIPTION OF THE DRAWINGS

FIG. 1 shows a system for communication between processors and a main memory according to aspects of the invention;

FIG. 2 shows a flow diagram of the process showing dynamic allocation of memory in accordance with aspects of the invention; and

FIG. 3 shows a flow diagram of the process showing handling of read/write requests in accordance with aspects of the invention.

### DETAILED DESCRIPTION OF EMBODIMENTS OF THE INVENTION

The invention is directed to system and process for communication between memory and processors in a blade server. Implementations of the invention include a memory blade communicating with a compute blade, e.g., through an interface/link, e.g., a peripheral component interconnect (PCI) express interface or another memory I/O bus, in order to dynamically partition main memory on the memory blade.

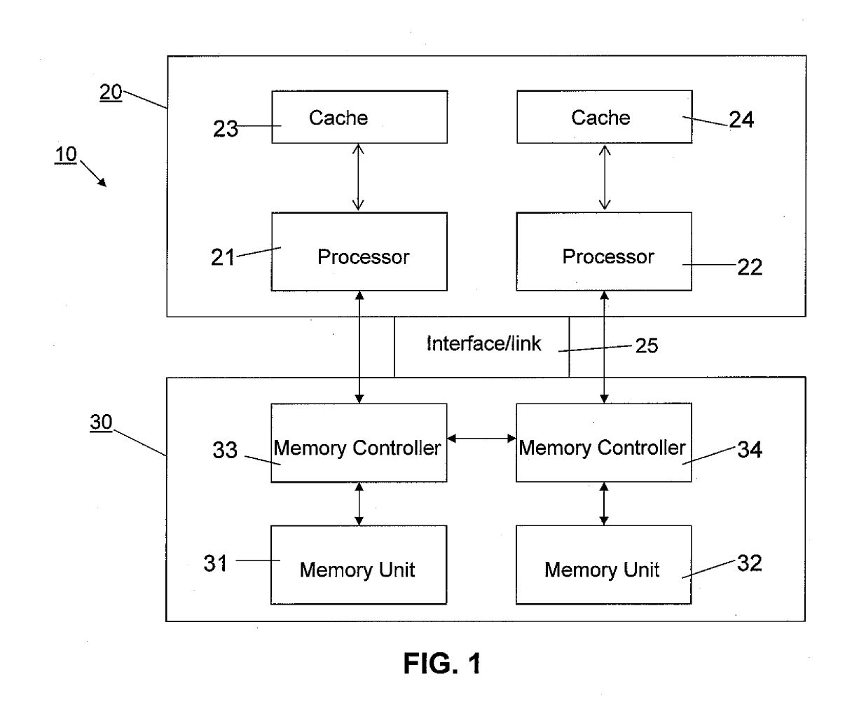

FIG. 1 shows a system 10 according to aspects of the invention. System 10 includes a compute (processor) blade (card) 20 and a memory blade (card) 30. Compute blade 20 includes a plurality of processors, e.g., two processors 21 and 22. However, the number of processors on the card can be any number defined by a customer, as long as blade dimensions and heat dissipation requirements are considered. Each processor has an associated direct attached memory 23 and 24, e.g., a 512 MB local memory, respectively, that is directly accessible by the respective processor to which it is associated. Moreover, processors 21 and 22 can be coupled to communicate with each other.

Memory blade 30 contains main memory composed of, e.g., memories 31 and 32, which can be formed by a single memory element or multiple memory elements, e.g., dual inline memory modules (DIMMs). Moreover, as the processors and their associated structure have been removed from memory blade 30, a larger number of DIMMs can be accommodated than on conventional blades. In embodiments, the memories are, e.g., 2 GB memories preferably formed by, e.g., multiple DIMMs having a capacity of, e.g., 256 MB each. Memory controllers 33 and 34 are coupled to each memory 31 and 32, respectively. Memory controllers 33 and 34 can be, e.g., field programmable gate arrays (FPGAs) or application specific integrated circuits (ASICs), which contain programmable logic components and programmable interconnects. Further, memory controllers 33 and 34 may include any combination of hardware (e.g., circuitry, etc.) and logical programming (e.g., instruction set, microprogram, etc.) that facilitates communication between the processors and memory units and between the memory controllers.

Compute blade 20 and memory blade 30 can be coupled through an interface/link 25, e.g., a PCI express link or another memory I/O bus, in order to facilitate communication between compute blade 20 and memory blade 30. In embodiments, at least one interface, such as a south bridge (not shown), is provided on compute blade 20 to couple processors 21 and 22 to memory controllers 33 and 34 through interface/link 25. In this way, memory controllers 33 and 34 translate requests, e.g., PCI express requests or requests through another memory I/O bus, from compute blade 20 into memory requests, e.g., DDR2/3, for DIMMs, such that processors 21 and 22 communicate with their associated memory controller 33 and 34, respectively, and thereby with their associated memory 31 and 32, respectively. Moreover, memory controllers 33 and 34 are arranged to communicate with each other, so that processors 21 and 22 have access to both memories 31 and 32. In an implementation of the invention, as memory controllers 33 and 34 control memories 31 and 32, communicate with processors 21 and 22 through interface/link 25, and communicate with each other, the main memory allocated to each processor 21 and 22 can be dynamically varied or partitioned. In this manner, depending upon the work load running on individual processors, differing sizes of memory can be allocated to respective processors.

As memory card 30 is not dependent upon a specific compute processor, the design of memory card 30 is relatively inexpensive, and the blade is usable to provide additional memory to compute nodes from different vendors. Accordingly, the customer is provided a more flexible system tailored to specific customer requirements. For example, as the amount of memory needed varies according to customer requirements, when a customer requires less memory, two compute blades can be used, and when a customer requires more memory, one compute blade and one memory blade can be employed.

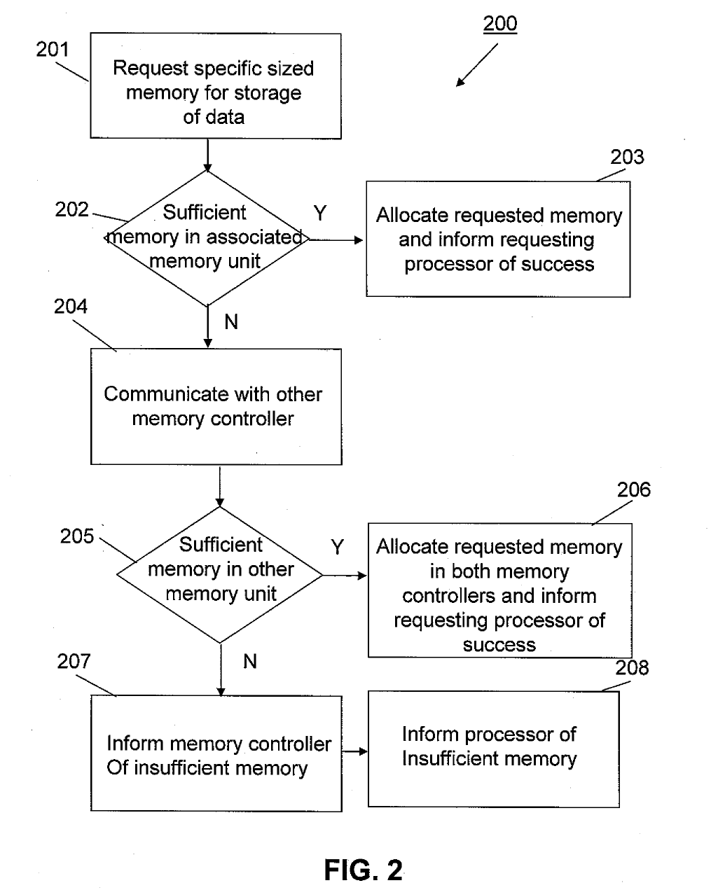

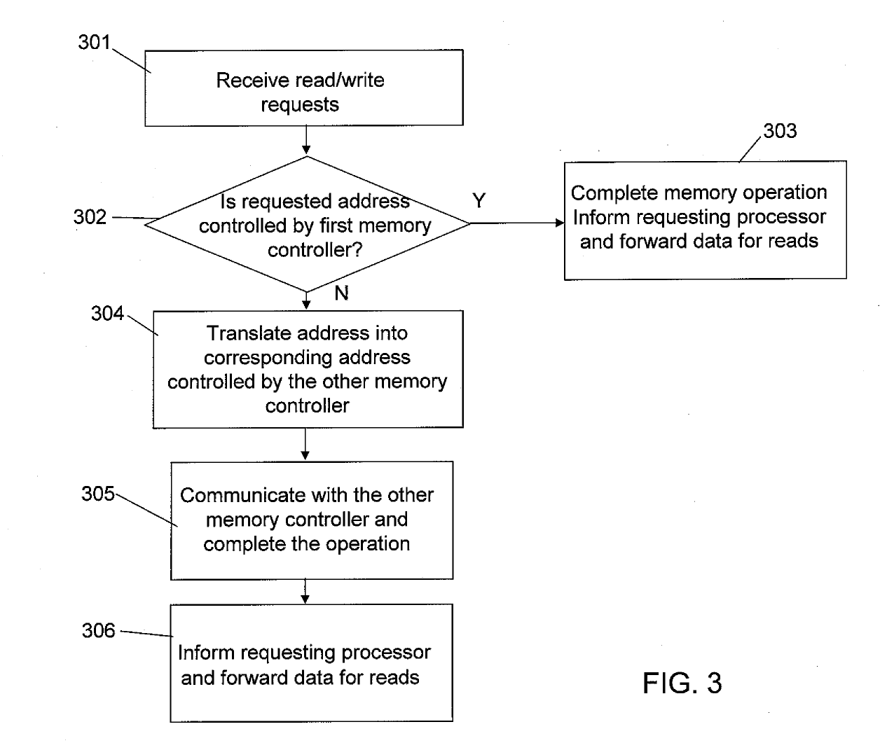

A flow diagram 200 of the dynamic partitioning of the memories is illustrated in FIG. 2, and a flow diagram 300 for handling read/write requests of the memories by the memory controllers is illustrated in FIG. 3. These flow diagrams are exemplary implementations of the invention. FIGS. 2 and 3 may equally represent high-level block diagrams of the invention.

The processes depicted in flow diagrams 200 and 300 may be implemented in internal logic of a computing system, such as, for example, in a memory controller, e.g., a FPGA or ASIC. Additionally, these processes can be implemented in the form of an entirely hardware embodiment, an entirely software embodiment or an embodiment containing both hardware and software elements.

In embodiments of dynamic partitioning flow diagram 200, one of the processors requests a specific sized memory for storage of data in 201. The request is transmitted through an interface, such as a south bridge, on the processor card, and through the interface/link to the memory controller associated with the processor. The memory controller interprets the request and determines at 202 whether sufficient sized memory is available in the associated memory unit. When sufficient sized memory is available, the memory controller allocates the requested memory, and a message is sent to the requesting processor at 203 that its request for memory allocation is successful.

When sufficient memory is not available in the associated memory unit, the memory controller at 204 communicates with another memory controller to request at least a portion of the other memory controller's memory in order to store some or all of the data. If sufficient memory is found in the other memory controller's memory unit to satisfy such a request, then that portion of the memory is allocated in both memory controllers to the requesting processor at 205. Further, a message is sent to the requesting processor at 206 that its request for memory allocation is successful. If sufficient memory is not found in the other memory controller's memory unit, the other memory controller informs the memory controller associated with the requesting processor that insufficient memory is available at 207, and the memory controller informs the processor that insufficient memory is available for the request at 208.

Because of the dynamic partitioning of the main memory on the memory blade, the memory associated with the processors is flexible in a manner not previously available. By way of example, assuming each processor on a compute blade, e.g., two processors, has a 512 MB direct attached memory and associated 2 GB DIMMs attached through the interface/link, the memory can be configured such that each processor is allocated 2.5 GB of memory, or, in an extreme case, one processor can be allocated 4.5 GB of memory while the other processor is allocated only 0.5 GB of memory, or any allocation in between based upon the requirements of the processors.

As noted above, flow diagram 300 of the handling of read/write requests of the memories by the memory controllers is illustrated in FIG. 3. In this exemplary diagram, it is assumed that each memory controller controls 2 GB of memory. Further, it is assumed that 3 GB of memory (0.5 GB direct attached memory and 2.5 GB of attached memory through the interface/link) has been allocated to the first processor and 2 GB of memory (0.5 GB direct attached memory and 1.5 GB of attached memory through the interface/link) has been allocated to the second processor, e.g., in the manner set forth in the flow diagram illustrated in FIG. 2. At 301, a request for read/write of the memory is received by the first memory controller. A request for read is accompanied by an address while a request for write is accompanied by both an address and data. At 302, the first memory controller finds out whether the requesting address is in its associated memory, i.e., the memory controlled by the first memory controller. When the requesting address is in the first memory controller's associated memory, the memory request is completed at 303, i.e., for reads, the requested memory location is read and the data is forwarded to the requesting processor, and for writes, the data is written to the requested memory location and the requesting processor is signaled that the request has been completed. When the first memory controller finds out the requested address is not in its associated memory, then at 304, the first memory controller translates this address to the corresponding address of the memory controlled by the other memory controller. At 305, the first memory controller communicates with the other memory controller to complete this operation. Moreover, the first memory controller, at 306, informs the requesting processor, in a write request, the requested operation is complete, or forwards the read data, in a read request, from the other memory controller to the requesting processor.

The invention as described provides a system and process for communication between processors and main memory. The invention may be implemented for any suitable type of computing device including, for example, blade servers, personal computers, workstations, etc.

While the invention has been described in terms of embodiments, those skilled in the art will recognize that the invention can be practiced with modifications and in the spirit and scope of the appended claims.

1. A system, comprising:
a processor card containing at least two processors;
a memory card, separate from the processor card, containing at least two memory units, in which at least one memory unit is associated with each processor; and
a controller to dynamically allocate memory in the at least two memory units to the at least two processors,
wherein the controller comprises at least two memory controllers, in which each of the at least two memory controllers is associated with a respective one of the at least two processors, such that each memory controller is arranged to dynamically allocate to its respective processor memory in the at least two memory units.

2. The system in accordance with claim 1, wherein the memory card further comprises the at least two controllers.

3. (canceled)

4. The system in accordance with claim 1, wherein the at least two memory controllers comprise field programmable gate arrays (FPGAs) or application specific integrated circuits (ASICs).

5. The system in accordance with claim 1, wherein the at least two memory controllers communicate with each other, whereby all of the at least two memory units are accessible to each processor through the at least two memory controllers.

6. The system in accordance with claim 1, further comprising a peripheral component interconnect express link coupling the processor card to the memory card.

7. A process of partitioning main memory between at least two processors in a blade server system, comprising:
a first memory controller receiving a request for specified sized memory from a first processor, wherein the first memory controller is assigned to the first processor;
the first memory controller communicating with a second memory controller assigned to a second processor, wherein the first and second processors are arranged on a processor card and the first and second memory controllers are arranged on a memory card separate from the processor card, and wherein each processor is assigned specified main memory; and
the first memory controller confirming to the first processor an allocation of space in the specified main memory assigned to the second processor.

8. (canceled)

9. (canceled)

10. The process in accordance with claim 7, wherein the request from the first processor is forwarded over a peripheral component interconnect express link.

11. A computer system, comprising:
first and second processors arranged on a processor card;
main memory composed of first and second memory units respectively assigned to the first and second processors, wherein the first and second memory units are arranged on a memory card separate from the processor card; and
first and second memory controllers respectively assigned to the first and second processors and to the first and second memory units and arranged to dynamically allocate memory in the first and second memory units to the first and second processors, wherein the first memory controller allocates memory in the second memory unit to the first processor through communication with the second memory controller.

12. (canceled)

13. (canceled)

14. The computer system in accordance with claim 11, wherein the first and second memory controllers comprise field programmable gate arrays (FPGAs) or application specific integrated circuits (ASICs) structured and arranged to communicate with each other.

15. (canceled)

16. The computer system in accordance with claim 11, further comprising a communications link between the processor card and the memory card.

17. The computer system in accordance with claim 11, wherein the memory card further comprises the controller.

18. The computer system in accordance with claim 11, wherein the first and second memory controllers comprise programmable logic components and programmable interconnects.

19. (canceled)

20. The computer system in accordance with claim 11, wherein each of the first and second memory units comprise a plurality of dual inline memory modules (DIMMs) and the first and second controllers comprise application specific integrated circuits (ASIC) structured and arranged to communicate with each other.
